(19) United States
(12) Patent Application Publication
(10) Pub. No.: US 2012/0248721 A1
(43) Pub. Date: Oct. 4, 2012

(54) Wood Log and Article Wheeled Barrow

(76) Inventor: Dale Dean, East Durham, NY (US)

(21) Appl. No.: 13/247,134

(22) Filed: Sep. 28, 2011

Related U.S. Application Data
(60) Provisional application No. 61/388,041, filed on Sep. 30, 2010.

(51) Int. Cl. B62B 1/00

(52) U.S. Cl. 280/47.31

(57) ABSTRACT

A wheeled, carrying device is disclosed, comprising of a frame and multiple platforms thereattached and angled at each end to hold firewood or other long rectangular items. On a front end of the device there are two handles for the user to direct the device. Vertical legs on a first end of the frame support the device when the user is not transporting articles. On the opposing end of the frame is a wheel attached thereto for rolling the device similar to a wheelbarrow. The device provides a user with a convenient means for transporting large quantities of wood without the limitations of a standard wheelbarrow container.

### CROSS REFERENCE TO RELATED APPLICATION

This application claims the benefit of U.S. Provisional Application No. 61/388,041 filed on Sep. 30, 2010, entitled “Wood Barrow.”

### BACKGROUND OF THE INVENTION

1. Field of the Invention

The present invention relates to a wheeled carrier for transporting and storage of wood logs such as firewood.

Wood stoves are being used as a source of primary or secondary heating in many homes today. Considerable amounts of wood logs are transported over time. After chopping and splitting several logs into firewood, consumers are then required to transport the wood to the wood stoves for consumption. Users may try to attempt this transportation via a wheelbarrow; however these devices are not ideally suited for the given task. Standard wheelbarrows include a container portion that is not shaped to accommodate long, rectangular items such as a wood log, and therefore may not hold wood properly or without some difficulty. The wood logs are difficult to align, and therefore tend to be loosely positioned within a wheelbarrow, making them prone to dislodge or tip the barrow during transport. Alternatives to the standard wheelbarrow include manually carrying the wood, piece by piece, to where the user needs to store or consume the wood logs. This alternative is user intensive and requires a considerable amount of time. A tool or device for moving the logs is much preferred over manually moving the logs from one location to another.

Several devices are described in the art for aiding in the transportation of articles. These apparatuses include vertical means to transport articles, apparatuses that are within a container and/or use a set of wheels; however these devices all present problems with the transportation of wood logs.

Industrial wheelbarrows are one such device; however these tend to be heavy structures and that can be unwieldy, which is not well suited for consumer use of transporting wood logs. Conversely, lightweight wheelbarrows one would find for small yard work are not structurally suited for carrying heavy loads imparted by a plurality of wood logs. Inadequate rigidity of the container or barrow frame can lead to wood being dropped at the slightest jar or uneven terrain or damage to the device, unless a minimal amount of logs is being transferred. This places a limit on the carrying capacity of these types of wheelbarrows, and therefore narrows its utility for such a task. Both types similarly limit the size of wood to the given container or tray dimensions, which is their primary drawback when utilized to carry wood logs. Other carrying devices with drawbacks associated with their use as wood log transport devices include those requiring a path wide enough to accommodate two wheels, those that limit the length of the wood or lack a means for securing the load.

The present invention solves these problems by providing a means for securely transporting large loads of wood logs in one trip. It also provides a means to easily store wood logs not in use or prior to use. The space provided for supporting the wood logs is without side restrictions, allowing logs to be placed and stacked in a flat, horizontal position. By providing a flat space for the logs, there is stability in the transportation due to even distribution of weight from one side of the vehicle to the other. The device further is made of a material and design suitable to support the weight of numerous logs in one trip, such as tubular frame of structurally support material adapted to support the weight of multiple logs.

2. Description of the Prior Art

The prior art contains a variety of wheeled carrier devices for transportation of articles. These devices have familiar design and structural elements for the purposes of transporting articles; however they are not structured for use of transporting wood logs by the most efficient means.

U.S. Pat. No. 4,758,010 to Christie discloses a convertible wheelbarrow. The wheelbarrow has a tray with connectors for quickly removing it from the frame which has a load carrying area behind, above and forward of the wheel. The tray does not allow for the use of the product with long rectangular items. This can be cumbersome for the user due to the fact that the user will have to carry items such as logs awkwardly and with no means of balance since the logs cannot fit evenly spaced.

U.S. Pat. No. 6,022,032 to Savage describes a firewood transport and storage device. The device comprises a portable wood rack having a tubular U-shaped base frame with a two-wheeled chassis assembly at one end and support stand at the opposite end. The support stand does not allow for maneuvering around a yard where there may be multiple obstacles in the way. The same can be said for the dual wheels. When ready for storage, a similar problem arises when the user must look for a level spot; however, since there is only one stand, the support may move from side to side providing instability. The base frame does not include a platform, so smaller logs or other rectangular items may not fit on the Savage device.

U.S. Pat. No. 4,261,590 to Schupbach describes a wheelbarrow frame. The device includes a pair of subframes each made of a continuous length of tubular material and held in spaced apart relationship to each other to form a load carrying platform above and rearwardly of a wheel supported between the subframes. The frame is adapted to be used with a bicycle wheel. The frame can be stored in a subassembled form. Carrying items such as wood logs, a user needs to have a smaller wheel so that the items are closer to the ground. Having the wheel set higher provides less stability for the items being transported. The higher wheel also limits the device to provide less room for the actual articles being transported.

U.S. Pat. No. 4,335,897 to Muller, Jr. is another cart with a removable container. The container of the device is removed while transferring objects. Similar to the Christie patent, the tray does not allow for the use of the product with long rectangular items. This can be cumbersome for the user due to the fact that the user will have to carry items such as logs awkwardly and with no balance of the device since the logs cannot fit evenly spaced thereon. Dual wheels do not allow for maneuvering around a yard wherein multiple obstacles may be situated along the way.

U.S. Pat. No. 4,343,483 to Base is another wheeled carrier for hauling logs having a frame rotatably supporting a pair of wheels, a panel member attached to the frame, and a handle for gripping the wheeled carrier. In the preferred embodiment, the carrier has two wheels on one side of the upright position. Logs are piled up to fill the space between the bent sides of the frame. In this U-shaped design a limited amount of logs may be placed. In a preferred embodiment of this device, it is not possible to have items in the device and have it available for storage. The items would make the device fall over, since there is no counterbalance on the opposite side of the wheels.

U.S. Pat. No. 4,469,341 to Creim describes an article rack and cart assembly. The rack is detachably coupled to the cart and comprises a pair of U-shaped support members, a pair of support legs and an article support surface configured in a U-shape to receive the articles. The rack has a small base, so that articles must be stacked vertically in order to transport. Due to this drawback, a limited amount of articles may be transported using this device.

The devices disclosed in the prior art do not address the need for a device that allows for storage and transportation of multiple wooden logs. The present invention relates to a device that allows a user to collect and place multiple logs thereon for transport, with a capacity that minimizes the number of trips otherwise required for the given amount of logs. The current invention also relates to a device that allows for storage of said wooden logs within a stable platform. Logs can be placed onto the device, and the device can then act as a static support for the logs over an extended period, as opposed to be used solely as a transport device. The structure and intent of the present invention substantially diverges in design elements from the prior art and consequently it is clear that a need exists for an improved transportation device that provides an efficient means of transporting and storing wooden logs. In this regard the instant invention substantially fulfills these needs.

### SUMMARY OF THE INVENTION

In view of the foregoing disadvantages inherent in the known types of article and wood carrying devices now present in the prior art, the present invention provides a new means to transport and store wood logs.

It is therefore an object of the present invention to provide a new and improved wood log carrying device that has all of the advantages of the prior art and none of the disadvantages.

Another object of the present invention is to provide a new and improved carrying device with open sides that can be used for supporting long, rectangular items in an organized manner that promotes stability.

Yet another object of the present invention is to provide a new and improved transportation device with a tubular frame, a plurality of support platforms, handles, a front-mounted wheel for moving the device and two support legs designed to stabilize the device while not being moved.

Still another object of the present invention is to provide a new and improved transportation device that has an angled platform section along the front and rear of the device to prevent articles from shifting during transport.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 there is shown is a perspective view of a preferred embodiment of the present invention.

FIG. 2 there is shown is a side view of a preferred embodiment of the present invention.

FIG. 3 there is shown is a top view of a preferred embodiment of the present invention.

FIG. 4 there is shown is a front view of a preferred embodiment of the present invention.

FIG. 5 there is shown a perspective view of the frame of a preferred embodiment of the present invention.

### DETAILED DESCRIPTION OF THE INVENTION

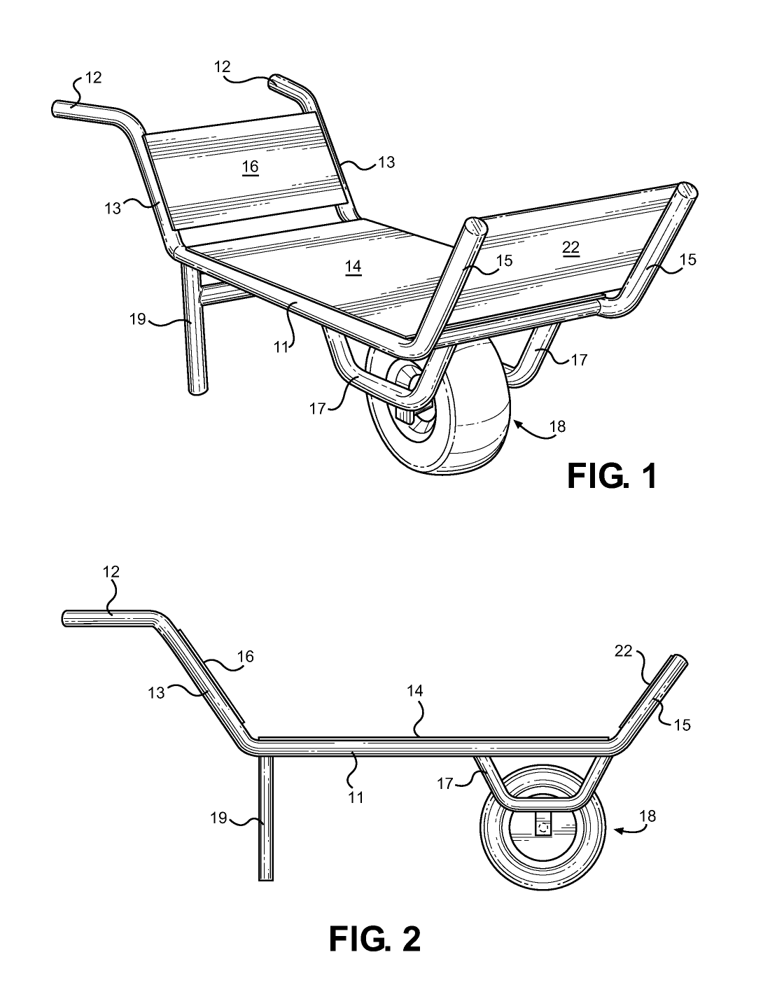

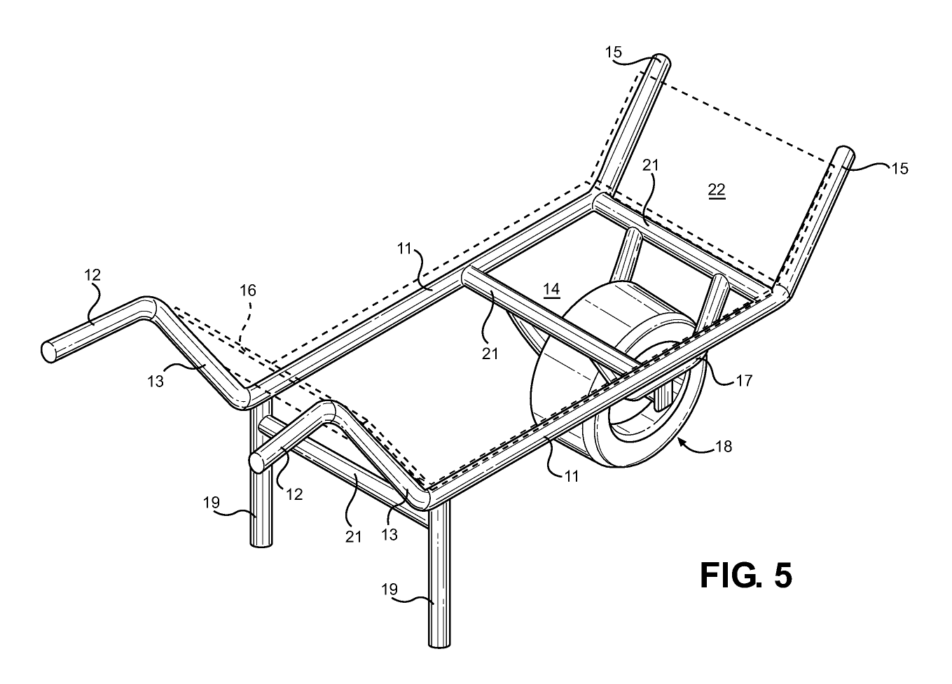

Referring now to FIG. 1 and FIG. 5, there is shown the wood log transportation device of the present invention. The device comprises a tubular frame supporting three planar platforms 14, 16, 22 at different angles, two vertical support legs 19 and a forward wheel assembly 18. The frame comprises of a first and second tubular side rail that forms a horizontal section 11, a forward angled section 15, a rear angled section 13 and a pair of handles 12 for the user. The flat section of the frame 11 provides support for a horizontal platform 14, while the forward 15 and rear 13 sections provide support for platforms angled from the horizontal, which act as supportive barriers for a plurality of layered wood logs placed onto the device. Between the first and second tubular members are two bridge sections 21 and a rear stand 19. The bridge sections 21 support the carried load on the horizontal platform 14 and maintain the position of the first and second tubular members. A forward wheel assembly is positioned between the two bridge sections 21, and comprises two axle support sections 17, a wheel and a wheel axle that allows free rotation of the wheel. The user handles 12 are formed from the rear sections 13 to allow a user to easily lift the rear stand 19 from a resting position and tilt the device about its forward wheel assembly 18. Once lifted, the device may be moved in a similar fashion as a standard wheel barrow, wherein the forward wheel rotates as the user applies a forward or rearward force and orients the angle of the wheel. No upstanding side supports are present on the device adjacent to the platforms 14, 16, 22, as the device is intended to accommodate varying lengths of wood and logs. The angled platforms 16, 22 at the front and rear of the frame prevent wood or other articles from sliding from the carrier or dislodging during the transport. They similarly allow a plurality of wood logs to be stacked cross-wise with respect to the device, wherein the ends of the stack are supported and prevented from moving forward or rearward during transport or storage.

Two support legs 19 designed to stabilize the invention while not in use, are located on the underside of the frame. The two support legs have a bridge member 21 for additional support and stabilization of the two independent legs 19. Attached to the underside of the forward half of the frame is a singular wheel assembly 18. The wheel assembly includes a wheel and a wheel axle that runs along the center of the wheel so that it extended from both sides of the wheel.

Referring now to FIG. 2, there is shown a side view of the device in a static position. The frame is shown from one side, wherein its unitary construction is visualized. The sides of the frame forms the user handle 12, forward and rear angled portions 15, 13 and also a horizontal portion 11. The two sides of the frame form a support for platforms 16, 14, 22, which are utilized to stack a plurality of items, mostly notably wood logs. The frame is sized and shaped to safely and securely stack and transport large quantities of wood on the platforms, without risk of wood departing the stack or the frame from structurally failing under the weight of the carried contents. The frame is supported above the ground by a forward wheel assembly 18 and a rear stand 19, which acts as a rear support when the device is stationary. In use, the rear stand 19 is lifted and the wheel assembly 18 is utilized to allow easy motion of the device with or without cargo. In this way, the device may act as a transport device, or likewise as a device to stack quantities of wood logs for an extended period of time, in a similar fashion as static log stackers, racks and holders.

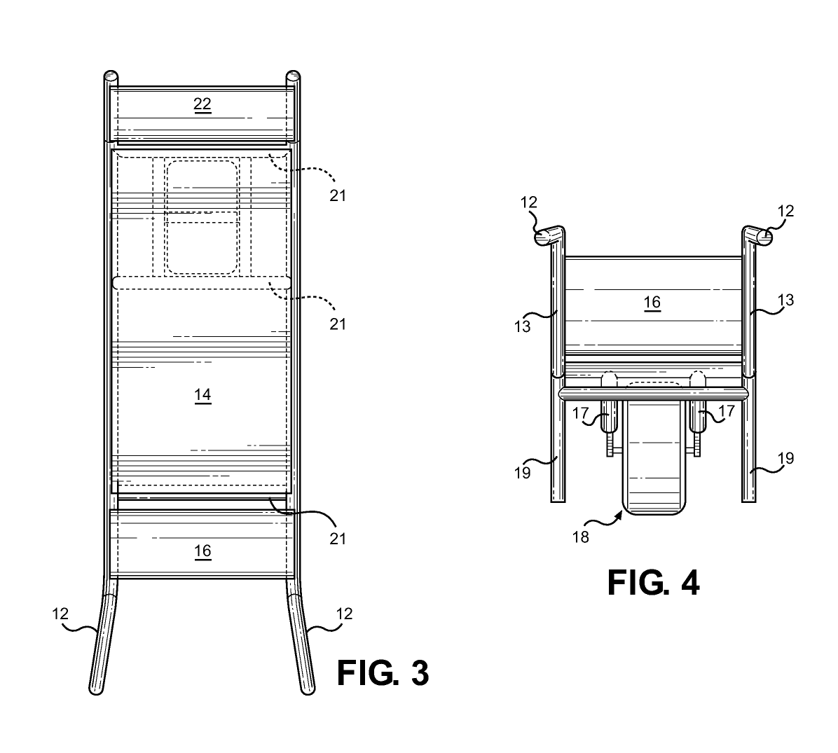

Referring now to FIG. 3, there is shown the device from an overhead view. From this vantage point, the overlapping placement of the platforms 16, 14, 22 are shown, wherein their lengths overlap the frame side portions and are attached thereto. The platforms are preferably welded to the frame for continuous attachment. Also contemplated are fastener attachment means that connect the platforms to the frame sections. The sections that comprise the frame are unitary lengths and welded sections that form the entire frame prior to attachment of the forward wheel assembly 18 and the platforms. The cross section of the frame may be any geometric shape and thickness deemed acceptable for hauling an anticipated weight of logs, and is dependent on the overall size of the device being utilized. The cross sections provided in the figures is that of round bar having a hollow interior section and wall thickness.

Referring now to FIG. 4, there is shown the device from the first end section. This view is shows the device from the user's end, wherein the rear stand 19 is lifted from a ground surface and the wheel is being forcibly rotated and angled by the user's input on the handles 12 to effect a translation and a heading orientation of the device while in use.

In use, an individual places wooden logs or similar articles on top of the horizontal platform 14. The logs are placed perpendicular to the first and second tubular side rail sections and piled such that the logs rest against both angled platforms 16, 22 for lateral support. The frame and platforms keep the logs secured so the logs do not dislodge from the device while in a stacked configuration, while the device is in motion or in a static position. While the device is not in motion and when the logs are being placed in the device, the two rear stand legs 19 provide stability and keep the device stationary. Once the device is filled to capacity or to a user's preference, the user raises the device by lifting the handles 12 such that the two stand legs 19 are lifted from the ground. The weight of the device and load will be placed on the platforms and frame, while the wheel supports the overall load the device and cargo. With forward or rearward force on the handles, the device is moved forward or rearward along the path and tilt orientation of the wheel 18. If are any unintended stops or bumps along the traveled path, the angled forward and rear sections provide security such that the load does not fall from the device. Once the device is at the preferred location, the user may lower the handles 12 to rest the rear stand legs 19 to the ground. The device can then be left in a static position without additional support or supervision. The load may be stored for a given period of time in this way or items can be removed at this time.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim the following:

1) A wheeled carrier for hauling logs or similar items, said carrier comprising:
a frame having a horizontal section, angled forward and rear sections, two handles, a forward wheel assembly support and a rear stand;
a forward, rear and horizontal platform attached to said forward, rear and horizontal frame section, respectively, for supporting load thereon;
a wheel assembly attached to said forward wheel assembly support, comprising a rotationally mounted wheel about an axle;
said angled sections extending from said horizontal section and being positioned at an angle with regard to a horizontal plane to provide forward and rear support for carried loads.

2) The device of claim 1, wherein said frame further comprises two unitary side rails that form a horizontal section, a forward angled section, a rear angled section and one of said handles.

3) The device of claim 2, wherein said frame further comprises bridge members that attach said side rails and form supports for said platforms, said platforms resting above said side rails and bridge members and being attached thereto.

4) The device of claim 3, wherein said attachment comprises a weld line.

5) The device of claim 3, wherein said attachment comprises a plurality of fasteners.

6) The device of claim 1, wherein said rear stand further comprise two upstanding legs.

7) The device of claim 1, wherein said forward wheel support comprises two axle support sections, a wheel axle, and a singular wheel, said wheel axle attached to said axle support sections and said wheel rotatably attached to said wheel axle about its center.

8) The device of claim 1, wherein said frame further comprises a tubular structure with a hollow interior and a wall thickness.
